(19) United States
(12) Patent Application Publication
(10) Pub. No.: US 2004/0023575 A1
(43) Pub. Date: Feb. 5, 2004

(54) Vacuum coated laminate and method for making same

(76) Inventors: Shailesh Chunilal Patel, Terre Haute, IN (US); James Peter Dipoto, Neenah, WI (US); Carl Douglas Ray, Terre Haute, IN (US)

Correspondence Address: FISH & RICHARDSON P.C., 5000 BANK ONE CENTER, 1717 MAIN STREET, DALLAS, TX, 75201, US

(21) Appl. No.: 09/543,314

(22) Filed: Apr. 5, 2000

(51) Int. Cl. D03D 15/00; B32B 27/04; B32B 27/12

(52) U.S. Cl. 442/4; 442/43; 442/46; 442/47; 442/49; 442/51; 442/58; 442/76; 442/86

(57) ABSTRACT

A vacuum coated, liquid impermeable, vapor permeable laminate article and a method for making same are disclosed. The laminate may be formed of a netting material which is coated with a thin layer of vapor permeable polymer and subsequently passed over a vacuum forming drum to draw the polymer coating downward into the openings in the netting material. Vacuum coating produces thinned regions in the coating layer which provide greater vapor permeability. In laminates with sufficiently large openings in the netting material, the coating may directly contact a vacuum forming screen resulting in a plurality small indentations or cells within a single thinned region of the liquid impervious coating further increasing vapor permeability.

### BACKGROUND OF THE INVENTION

1. Technical Field of the Invention

The present invention relates to a vacuum coated laminate and method for making same. Specifically, the vacuum coated laminate of the present invention provides liquid impermeability while remaining moderately permeable to water vapor.

2. History of Related Art

The vacuum coated laminate of the present invention is suitable for use in a variety of applications including disposables, such as backsheets for diapers and feminine hygiene products; substrates for bandages; breathable packaging materials; and insulating housewrap materials.

For such applications, the prior art broadly teaches the use of either very fine spun-bonded polyolefins or laminates consisting of breathable, microporous films which are either thermally or chemically bonded to nonwovens. There are also several references which disclose laminates which are formed by coating a substrate with a molten polymer. One coating technique produces a laminate by extruding a polymer coating onto a nonwoven and then passing the coated nonwoven through a nip roll arrangement. Another approach involves extruding a polymer coating onto one side of a nonwoven and subjecting the opposite side of the nonwoven to a vacuum.

Many prior art laminates, however, tend to suffer from an inability to precisely control moisture vapor transmission rates (MVTR). In some applications, it has proven difficult to create durable, liquid impermeable materials with MVTR levels which are high enough to efficiently transport water vapor across the laminate. This is because thinner films will normally provide higher permeability, but as films are made thinner they lose strength and tend to rupture more easily. Accordingly, many prior art materials are film/nonwoven laminates having breathable, microporous films or apertured films as coatings which may not be substantially water impervious or may produce MVTR levels high enough to result in condensation of water on the laminate surface. Prior art laminates formed by coating methods have also been somewhat limited in that it is difficult to make coatings on typical spun-bonded or staple fiber nonwoven substrates significantly thinner without rupturing them.

Thus, there is a need for new vacuum coated laminate materials, suitable for use in a variety of applications, which are liquid impermeable, moderately breathable, and possess more precisely controlled MVTR levels.

### SUMMARY OF THE INVENTION

The present invention overcomes the foregoing and other problems with a vacuum coated laminate for use as a liquid impervious, moderately breathable material. The laminate is formed of a netting material substrate which is coated with a moderately breathable polymer compound. The polymer coating, may be blended with suitable additives to provide anti-block, ultraviolet light resistence, and white pigmented opacity properties.

In one method of manufacture, the laminate of the present invention is formed by the extrusion coating of a polymer compound onto a netting material with a large percentage of open area. The coated netting material is then passed over a vacuum-forming drum which draws the somewhat molten coating material into the openings of the netting, partially enveloping each of the fibers and resulting in good adhesion. The level of vacuum pressure is kept such that it forms and shapes the laminate film, but does not create any holes or apertures in the coating layer. The laminate may also be corona treated, preferably on the netting material side to make the laminate printable.

### BRIEF DESCRIPTION OF THE DRAWINGS

A more complete understanding of the method and apparatus of the present invention may be obtained by reference to the following Detailed Description taken in conjunction with the accompanying Drawings wherein:

FIG. 1 is a top plan view of a liquid impermeable, vacuum coated, film/netting laminate article, according to one embodiment of the present invention and showing the thinned regions located in each of the open areas of the netting material and a plurality of cells located within each of the thinned regions;

FIG. 2 is a cross sectional view of a liquid impermeable, vacuum coated, film/netting laminate article, according to one embodiment of the present invention and showing the manner in which the coating is drawn into the open areas of the netting material to form thinned regions;

FIG. 3 is a side elevational view of a vacuum coating arrangement for producing a film/netting laminate article, according to the method of the present invention.

### DETAILED DESCRIPTION

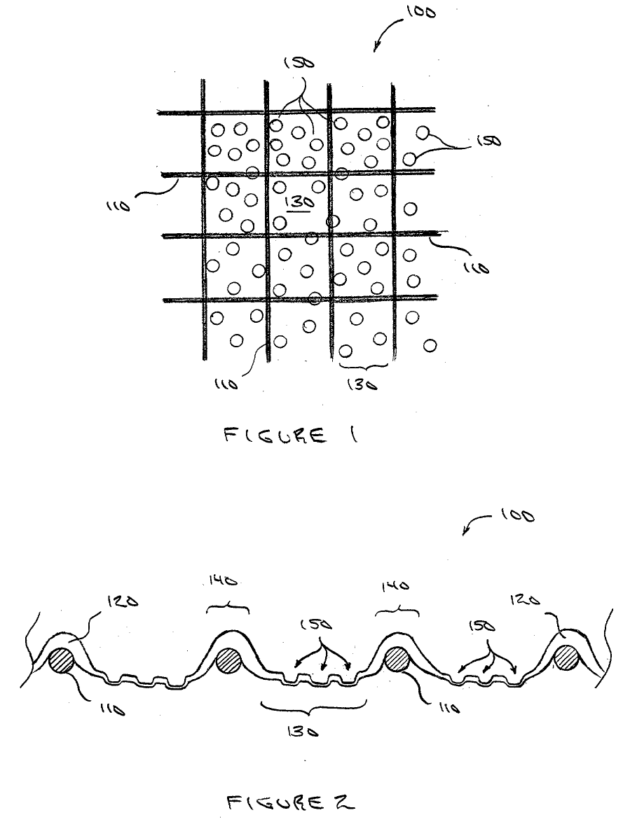

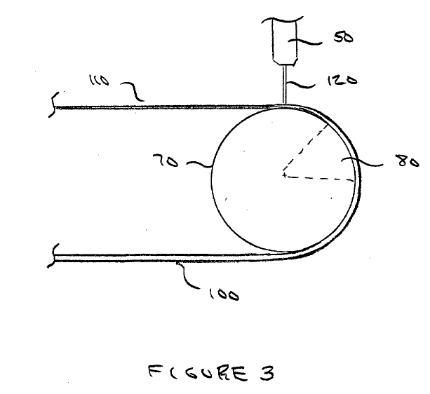

Referring now to the drawings, and more particularly to FIGS. 1 and 2, there is shown an embodiment of the present invention illustrated as the vacuum coated, film/netting laminate article 100. As shown in FIGS. 1 and 2, the laminate 100 generally includes a netting material 110 with a large percentage of open area, and a substantially liquid impermeable coating layer 120.

The netting material 110 provides the laminate 100 with strength, in both machine and transverse directions, while maintaining a relatively large percentage of open area. The netting material 110 may be selected from any number of thermoplastic materials including, by way of example, polyolefins, polyesters, nylons, and blends thereof. The netting material 110 may also contain various additives, as known in the art, to provide resistance to ultraviolet (UV) light and to impart flame resistant properties. In one preferred embodiment, the netting material 110 selected may be a bi-component material having a core of high-density polyethylene (HDPE) and a sheath of a material selected from the group including: low-density polyethylene (LDPE), linear low-density polyethylene (LLDPE), and metallocene linear low-density polyethylene (mLLDPE).

The netting material 110 will typically have an open area of about 50% to about 70%, and in one preferred embodiment has an open area of about 60%. However, if a particularly vapor permeable coating layer 120 such as a monolithic copolyester is selected, a netting material 110 with an open area of as little as 20% may be suitable.

The netting material may be either a woven or nonwoven open-meshed material having strands or fibers which are connected or attached one to another to define a plurality of open areas which extend completely though the material. As best seen in FIG. 1, the netting material 110 in one preferred embodiment has a particular regular repeating geometric latticework appearance to its structure. As shown in FIG. 1, this happens to be a square grid design, but it is to be understood that the netting material 110 may be formed to appear like a network of diamonds, triangles, circles, or any other shape which would result in a mesh having a regular or irregular pattern of open areas which extend completely through the netting material 110.

As noted earlier, the netting material 110 generally serves to provide a measure of strength and stiffness in the laminate 100. The laminate 100 should be able to withstand a load of about 20 pounds/inch in both the machine and cross machine directions according to ASTM D882. Additionally, the laminate should have a sufficient amount of stiffness so as to be handled without difficulty.

The coating layer 120 of the laminate 100 must be both liquid impermeable and vapor permeable. Coating thickness is typically an average which is determined by weighing a sample of laminate 100 having a known area, subtracting the weight of the same area of netting material 100, and then dividing the sum by the density of the coating material. Generally, the coating layer 120 will be about 1 mil in thickness. However, it is believed that the coating layer 120 may range from about 0.5 to about 3.0 mils in thickness and still produce a functioning laminate 100. Coating layers 120 ranging from about 0.7 to about 1.2 mils in thickness are more preferred, and coatings ranging from about 0.9 to about 1.0 mils in thickness are most preferred.

In one preferred embodiment, the coating layer 120 is a substantially non-porous, yet moderately breathable ethylene methyl acrylate (EMA) copolymer. The EMA copolymer may be further compounded with various additives, such as titanium dioxide, to provide white pigmented opacity, ultraviolet (UV) light resistance, and anti-block properties. The EMA material can be further compounded to give anti-static and fire retardant properties. It is also possible to adjust or control the physical characteristics of the coating layer 120 by selecting EMA copolymers with various percentages of methyl acrylate content and particular melt indices.

The EMA copolymer of the coating layer 120 in one preferred embodiment would have a methyl acrylate content of between about 20% and about 27%, but in other embodiments the methyl acrylate content can go as low as about 6% and still produce a functional coating layer. Also, the melt index of the EMA material of the coating layer 120 in one preferred embodiment will range from about 1 to about 6 grams/10 min.

The EMA copolymer of the coating layer 120 forms a non-porous, hydrophobic coating on the netting material 110, and is substantially impervious to water and other liquids. Although EMA film is normally considered hydrophobic, this particular coating 120 is surprisingly vapor permeable when made sufficiently thin, as in the laminate 100 of the present invention. It is known that water vapor is able to diffuse into the coating 120 on one side and emerge on the opposite side. However, it has been observed that to achieve useful levels of vapor permeability the coating must be quite thin, about 1 mil in thickness, as noted above. It is also understood that, while this coating is initially applied to the netting material 110 with a fairly uniform thickness, the subsequent process of vacuum forming the laminate 100 causes the coating layer 120 to be drawn down into the openings of the netting material 110, and toward a forming screen, resulting in thinned regions 130.

Indeed, it is one of the unique physical attributes of the laminate of the present invention that the coating layer has discrete thick regions 140 and thinned regions 130 spaced across the surface. The thick regions 140 correspond with the portions of the coating 120 which are supported by or resting upon the strands of the netting material 110, and the thinned regions 130 correspond with the portions of the coating 120 which are not supported by and are drawn downward into the openings of the netting material 110. This feature is unique in that if the coated netting laminate were nipped or calendered, instead of vacuum formed, the pattern of thick and thinned regions would be reversed. In short, if the laminate 100 were made by more traditional means, the coating material 120 would tend to be pushed off the fibers and into the openings of the netting material 110.

In one embodiment of the present invention, the thinned regions 130 of the coating layer 120 include a plurality of small indentations or cells 150. These small indentations or cells 150 may be formed as the coating layer 120 is drawn through the openings of the netting material 110 and into direct contact with the vacuum forming screen. The size, spacing and arrangement of these cells 150 is determined by the hole pattern of the vacuum forming screen. By allowing the coating layer 120 to contact the screen, portions of the thinned regions 130 can be drawn into the openings of the screen and made even thinner without rupturing the film. Each hole in the screen produces a dimple or cell 150 in the coating 120. A plurality of cells 150 within each thinned region 130 can reduce the average coating thickness within these regions to about 0.5 mils or less, and significantly increase the permeability and MVTR of entire laminate 100. It is to be understood that, although the cells 150 depicted are circular in shape, these small indentations may be square, hexagonal, or any shape, and may be sized and arranged in any configuration which corresponds to the openings in a vacuum forming screen.

As best seen in FIG. 3, one preferred method for forming the laminate structure of the present invention is shown in which the netting material 110 is coated with the liquid impermeable layer 120 as it descends in its molten state from a die 50 attached to an extruder (not shown) as known in the art.

The coated netting then passes over a vacuum forming drum or screen 70 rotatably mounted to pass over a vacuum nozzle or slot 80 which applies a sufficient level of vacuum pressure to the netting side of the laminate to form and shape the laminate 100 but avoid rupturing the liquid impervious coating 120. This process ensures that the coating layer 120 properly envelopes the netting layer 110 so as to give high lamination bonds. A laminate 100 formed in this manner will have an outer coating 120 substantially without holes which provides the laminate 100 with liquid impermeability, yet is moderately permeable to water vapor.

After the vacuum coating steps are complete, the finished laminate 100 may be corona treated (not shown) for printability and is taken up and wound on rolls (not shown) at low winding tension and low contact pressure to prevent blocking or self-adhesion of one layer of the laminate material 100 to another.

With reference again to FIG. 3, it should be noted that the vacuum pressure applied during the forming process is sufficient to form the laminate and to achieve strong lamination bonds between the coating 120 and the netting material 110. Typically, the vacuum pressure which must be applied during this step will range from about 2.0 to about 5.0 inches of mercury, depending upon coating thickness. By way of example, a vacuum pressure of about 2.0 to about 3.5 inches of mercury will usually be sufficient for coatings which are about 0.9 to 1.0 mil thick. It should further be noted that by controlling extrusion speeds and line speeds, it is also possible to adjust the thickness of the coating layer 120.

Although EMA copolymers are described herein as being particularly suitable for use as the coating layer 120, it is understood that this process can also be used to coat the netting material 110 with other polymers and compounds, including copolyesters (such as Hytrel® produced by DuPont), ethylene vinyl acetate (EVA) copolymers, ethylene normal butyl acetate (ENBA) copolymers, ethylene acrylic acid (EAA) copolymers, ethylene methyl acrylic acid (EMAA) copolymers, ethylene acid terpolymers containing methyl acrylate and acrylic acid (such as Escor®), styrene-butadiene copolymers (such as K-resins®), and styrenic block copolymers (such as SBS, SEBS, SEPS, and blends thereof including Kraton®).

As noted earlier, the polymer used to form the coating layer 120 of the laminate may be compounded with various additives. One particularly useful group of additives are those which enhance the anti-block properties of the resulting laminate 100. Even relatively small amounts of blocking or adhesion between the exterior surface of the coating layer 120 and the exterior surface of the netting material 110 which are adjacent to each other when taken up onto a roll, may produce pinholes in the extremely thin, liquid impervious, coating layer 120. Although, various liquid slip agents are available and would significantly reduce blocking, these additives tend to make subsequent marking or printing of the laminate extremely difficult. Accordingly, various dry anti-block agents including, by way of example only, diatomaceous earth, calcium carbonate, and talc are generally preferred. Diatomaceous earth has proven to be particularly useful in experimental trials for the production of the laminate of the present invention. Specifically, it has been determined that when quantities ranging from about 500 to about 6000 parts per million (ppm), and more preferably about 2500 ppm, of diatomaceous earth is compounded or blended with an EMA copolymer prior to coating the netting material 110 to form the laminate 100, blocking is greatly reduced and pinholes in the coating layer 120 may be substantially prevented.

It is critical in many applications, to produce laminate films of reasonably high strength which are both liquid impermeable and have a desired level of vapor permeability. In laminates used in housewrap applications, for example, MVTR levels according to ASTM E96 should be higher than about 35 g/m² per day (or 5.0 perms), yet low enough to prevent condensation problems on inner walls in high humidity climates. Prior art housewrap materials typically have MVTR levels ranging from about 380 to about 750 g/m² per day, and quite commonly have MVTR levels ranging from about 520 to about 590 g/m² per day. In contrast, one embodiment of the laminate material 100 of the present invention will have MVTR levels no higher than about 400 g/m² per day with levels of about 35 to 250 g/m² per day being more preferred and levels of 50 to 150 g/m² per day being most preferred. Test data for several EMA copolymer laminates on a netting material having about 60% open area is collected in the table below:

TABLE 1

| Thickness (mils) | Vacuum (inches Hg) | MVTR (g/m²/day) |
|---|---|---|
| 0.65-0.70 | 4.2 | 118 |
| 0.90 | 4.6 | 72 |
| 1.50 | 5.4 | 69 |

Lower MVTR levels allow the laminate 100 of the present invention to achieve the required level of breatheability (i.e. greater than 35 g/m² per day) while keeping MVTR levels low enough to prevent reverse transmission and subsequent condensation of water on inner walls in humid climates.

It is thus believed that the operation and construction of the present invention will be apparent from the foregoing description of a preferred embodiment. While the device and method shown are described as being preferred, it will be obvious to a person of ordinary skill in the art that various changes and modifications may be made therein without departing from the spirit and scope of the invention, as defined in the following claims. Therefore, the spirit and scope of the appended claims should not be limited to the description of the preferred embodiments contained herein.

What is claimed is:

1. A liquid impervious, vapor permeable, coated laminate material comprising:
a netting having a plurality of open areas;
a liquid impervious coating adhered to said netting, said liquid impervious coating comprising an ethylene methyl acrylate copolymer; and
said liquid impervious coating having a plurality of non-ruptured, vapor permeable thinned regions corresponding to the plurality of open areas in said netting.

2. The coated laminate material of claim 1, wherein said ethylene methyl acrylate copolymer includes a methyl acrylate content ranging from about 6% to about 27%.

3. The coated laminate material of claim 1, wherein said thinned regions contain a plurality of non-ruptured cells.

4. The coated laminate material of claim 1, wherein said thinned regions of said liquid impervious coating are about 0.5 mils in thickness or less.

5. The coated laminate material of claim 1, wherein said coating has a thickness of about 0.5 to about 3.0 mils.

6. The coated laminate material of claim 1, wherein said coating has a thickness of about 0.7 to about 1.2 mils.

7. The coated laminate material of claim 1, wherein said netting has at least a 50% open area.

8. The coated laminate material of claim 1, wherein said netting further comprises a bi-component material having a core of high-density polyethylene (HDPE) and a sheath of a material selected from the group consisting of: low-density polyethylene (LDPE), linear low-density polyethylene (LLDPE), and metallocene linear low-density polyethylene (mLLDPE).

9. The coated laminate material of claim 1, wherein said coating further comprises an anti-block additive.

10. The coated laminate material of claim 9, wherein said anti-block additive is diatomaceous earth.

11. A liquid impervious, vapor permeable, coated laminate material comprising:
a netting having a plurality of open areas;
a liquid impervious coating adhered to said netting, said liquid impervious coating comprising a copolyester; and
said liquid impervious coating having a plurality of non-ruptured, vapor permeable thinned regions corresponding to the plurality of open areas in said netting.

12. The coated laminate material of claim 11, wherein said netting has at least a 20% open area.

13. The coated laminate material of claim 11, wherein said thinned regions contain a plurality of non-ruptured cells.

14. The coated laminate material of claim 11, wherein said thinned regions of said liquid impervious coating are about 0.5 mils in thickness or less.

15. The coated laminate material of claim 11, wherein said coating has a thickness of about 0.5 to about 3.0 mils.

16. The coated laminate material of claim 11, wherein said coating has a thickness of about 0.7 to about 1.2 mils.

17. The coated laminate material of claim 11, wherein said netting has at least a 50% open area.

18. The coated laminate material of claim 11, wherein said netting further comprises a bi-component material having a core of high-density polyethylene (HDPE) and a sheath of a material selected from the group consisting of: low-density polyethylene (LDPE), linear low-density polyethylene (LLDPE), and metallocene linear low-density polyethylene (mLLDPE).

19. The coated laminate material of claim 11, wherein said coating further comprises an anti-block additive.

20. The coated laminate material of claim 19, wherein said anti-block additive is diatomaceous earth.

21. A liquid impervious, vapor permeable, coated laminate material comprising:
a netting having a plurality of open areas;
a liquid impervious coating adhered to said netting, said liquid impervious coating comprising a polymer selected from the group consisting of: ethylene vinyl acetate copolymers, ethylene normal butyl acetate copolymers, ethylene acrylic acid copolymers, ethylene methyl acrylic acid copolymers, ethylene acid terpolymers containing methyl acrylate and acrylic acid; and
said liquid impervious coating having a plurality of non-ruptured, vapor permeable thinned regions corresponding to the plurality of open areas in said netting.

22. The coated laminate material of claim 21, wherein said thinned regions contain a plurality of non-ruptured cells.

23. The coated laminate material of claim 21, wherein said thinned regions of said liquid impervious coating are about 0.5 mils in thickness or less.

24. The coated laminate material of claim 21, wherein said coating has a thickness of about 0.5 to about 3.0 mils.

25. The coated laminate material of claim 21, wherein said coating has a thickness of about 0.7 to about 1.2 mils.

26. The coated laminate material of claim 21, wherein said netting has at least a 50% open area.

27. The coated laminate material of claim 21, wherein said netting further comprises a bi-component material having a core of high-density polyethylene (HDPE) and a sheath of a material selected from the group consisting of: low-density polyethylene (LDPE), linear low-density polyethylene (LLDPE), and metallocene linear low-density polyethylene (mLLDPE).

28. The coated laminate material of claim 21, wherein said coating further comprises an anti-block additive.

29. The coated laminate material of claim 28, wherein said anti-block additive is diatomaceous earth.

30. A method for making a liquid impervious, vapor permeable, coated laminate material comprising the steps of:
extrusion coating a first surface of a netting having a plurality of open areas with a liquid impervious coating material to produce a coated netting;
applying a vacuum to a second side of said coated netting to produce a laminate material such that a plurality of non-ruptured, vapor permeable thinned regions are formed in said coating that correspond to the open areas in the netting.

31. The method of claim 30, further comprising the step of forming a plurality of non-ruptured cells in said thinned regions.

32. The method of claim 30, wherein said liquid impervious coating material is an ethylene methyl acrylate copolymer.

33. The method of claim 32, wherein said ethylene methyl acrylate copolymer includes a methyl acrylate content ranging from about 6% to about 27%.

34. The method of claim 30, wherein said liquid impervious coating material is a polymer selected from the group consisting of: copolyesters, ethylene vinyl acetate copolymers, ethylene normal butyl acetate copolymers, ethylene acrylic acid copolymers, ethylene methyl acrylic acid copolymers, ethylene acid terpolymers containing methyl acrylate and acrylic acid.

35. The method of claim 30, further comprising the step of supporting the coated netting on a forming screen having a plurality of openings therethrough during the step of applying a vacuum.

36. The method of claim 35, further comprising the step of forming a plurality of non-ruptured cells in said thinned regions corresponding to the plurality of openings in said forming screen.

37. The method of claim 30, wherein the step of applying a vacuum further comprises a vacuum pressure of about 2.0 to about 5.0 inches of mercury.

38. The method of claim 30, wherein said netting has at least a 50% open area.

39. The method of claim 30, further comprising the step of blending said liquid impervious coating material with an anti-block additive prior to extrusion coating said netting.

40. The method of claim 39, wherein said anti-block additive is diatomaceous earth.
